(19) United States
(12) Patent Application Publication
(10) Pub. No.: US 2004/0025352 A1
(43) Pub. Date: Feb. 12, 2004

(54) Citrus peeler

(76) Inventor: Michael J. Vitucci, Milwaukee, WI (US)

Correspondence Address: RYAN KROMHOLZ & MANION, S.C., POST OFFICE BOX 26618, MILWAUKEE, WI, 53226, US

(21) Appl. No.: 10/215,155

(22) Filed: Aug. 8, 2002

(51) Int. Cl. B26B 3/00; A47J 25/00

(52) U.S. Cl. 30/123.5; 30/169; 30/113.1; 30/314; 30/315; 30/356

(57) ABSTRACT

A manual tool for removing the rind from a piece of fruit, the tool having an ovoid, whole fruit-shaped handle, a radially extending, arcuate blade and a radially extending finger rest located intermediate the handle and blade. The finger rest includes oppositely disposed, concave sides to fit the contours a user's fingers, and can be used by both left and right-handed users.

### BACKGROUND OF THE INVENTION

1. Field of the Invention

The present invention relates generally to kitchen tools and specifically to a manual tool for peeling fruits having thick rinds, such as lemons.

2. Description of the Prior Art

It is often desirable to remove the rind or zest of citrus fruits, such as lemons, for use by itself. For example, lemon zest is often required in the preparation of cocktails. However, it is relatively difficult to efficiently and quickly remove tough citrus zest in one piece. Furthermore, in the commercial food preparation industry, such as bartending, a single night of cocktail preparation may require the zest of dozens of lemons. Much time is needed to prepare the food and beverage before it is actually served. Many drinks require a twist, which is made from the rind of a citrus fruit. Thus, an efficient way of removing the rind from the fruit is needed.

Many specialty tools have been developed, but they have not sufficiently addressed the problem for removing the rind from a citrus fruit. For instance, Lovato et al., U.S. Pat. No. 3,913,226, and Polk, U.S. Pat. No. 1,452,930, show citrus cutters with curved blades. However, the shape of the blade is orientated to fit the contour of a round fruit, and is not as efficient for oblong shaped fruit like lemons and limes. Also, the handle is not as easy to grip as the current invention. Likewise, the previous inventions have been concerned with the interior of the fruit and not necessarily with preserving the rind.

### SUMMARY OF THE INVENTION

The present invention offers a solution to expedite the removal of rind or zest from fruits, such as lemons, by way of a novel tool. The tool of the present invention includes a handle portion adapted for comfortable manual grip and a rinding surface or blade portion extending therefrom. The handle portion may take the form of the whole fruit to be peeled, for example a lemon, lime, or any other feasible shape. The blade portion extends from the handle and is uniquely configured to mimic the arcuate contour of the fruit to be peeled. The blade is also preferably beveled along its length to better loosen the rind from the fruit. The distal end of the blade is relatively pointed and is adapted to puncture the fruit to thereby gain access to the area of the fruit between the rind and the meat. Preferably, the ends of the fruit to be peeled are initially cut off to allow better insertion of the blade tip portion.

With the blade in place between the rind and meat, relative rotational motion between the fruit and the blade member is supplied, and the blade portion circumscribes the fruit. This action pulls the peel from the fruit body. After the peel is loosened from the fruit, the loosely surrounding rind may be removed by cutting longitudinally to cause the peel to fall away from the fruit. The removed peel may be used for zest or garnish, or may be stored for later use.

It is an object of the present invention to provide a citrus peeler including a handle that is comfortable and easy to use. The generally ovoid or fruit-shaped handle of the present invention allows the user to easily grasp and use the peeler. Further, the present invention includes a finger rest that assists the user in derinding a citrus fruit, by providing protection means to minimize finger abrasion during use.

These and other features of the present invention will be further described in the following detailed description.

### DESCRIPTION OF THE DRAWINGS

FIG. 1 is a side elevational view of the citrus peeler of the present invention.

FIG. 2 is a top plan view of the peeler in FIG. 1.

FIG. 2A is a view similar to that of FIG. 2, but showing the handle and finger grip as one piece construction.

FIGS. 3, 4 and 5 are perspective views of the citrus peeler illustrated in FIGS. 1 and 2 in use during derinding of a citrus fruit.

FIG. 6 is a side elevational view of an alternative embodiment of the present invention and showing a lime shaped handle.

FIG. 7 is a side elevational view of an alternative embodiment of the present invention and showing an orange shaped handle.

### DETAILED DESCRIPTION

Although the disclosure hereof is detailed and exact to enable those skilled in the art to practice the invention, the physical embodiments herein disclosed merely exemplify the invention that may be embodied in other specific structures. While the preferred embodiment has been described, the details may be changed without departing from the invention, which is defined by the claims.

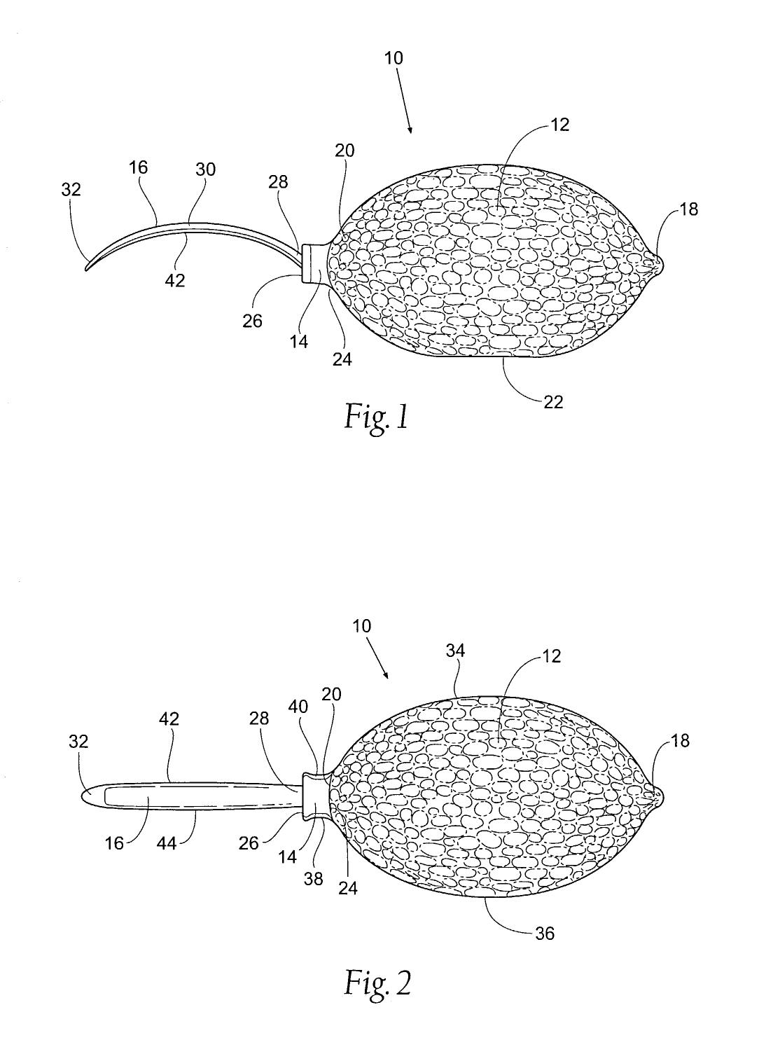

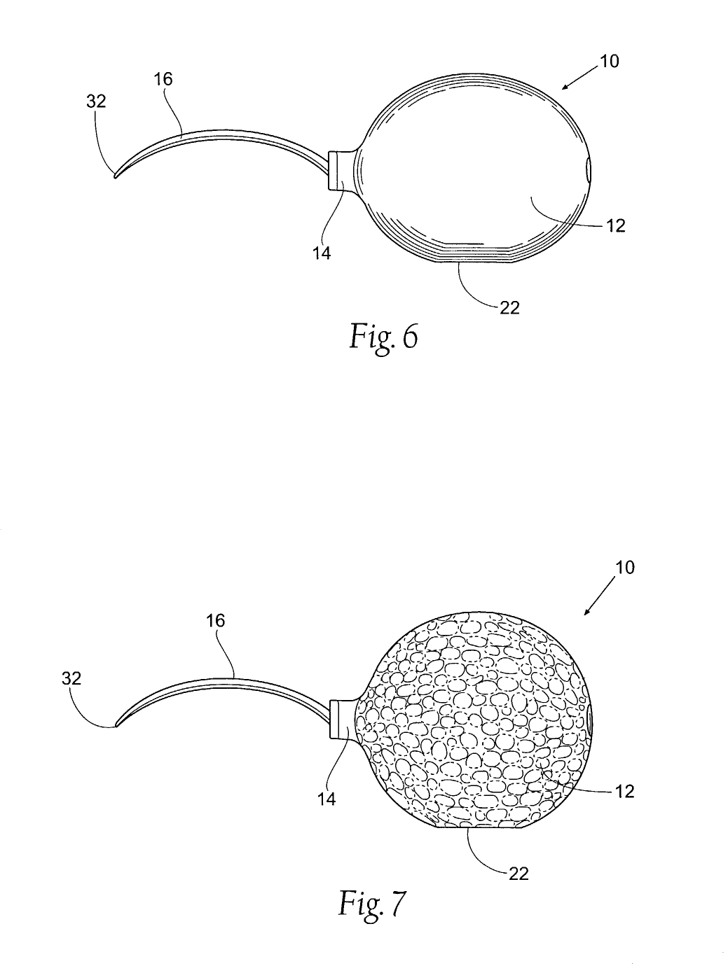

FIG. 1 shows a side view of an embodiment of the citrus peeler 10 of the present invention. The citrus peeler 10 preferably includes a handle member 12, a finger rest 14, and a laterally extending rinding surface, seen as a blade member 16. As shown, the handle member 12 is of generally ovoid, fruit shape, having a distal end 18 and a proximal end 20. The distal end 18 forms a nipple shape, similar to the end of a citrus fruit, such as a lemon or a lime. A blade member 16 extends from the proximal end 20 of handle member 12. As seen particularly in FIG. 1, the handle member 12 further includes a flattened bottom surface portion 22. Flattened bottom surface portion 22 aids in preventing rollover of the peeler 10 while at rest on a flat surface, such as a table (not shown). Further, flattened bottom portion 22 may be engraved with a company logo or other personalization, if desired. The shape of the handle 12 not only facilitates a good grip on the peeler 10 during use, but also provides an aesthetic appeal as it is preferably designed to resemble a fruit, seen as a whole lemon in the views of FIGS. 1-5, a lime in FIG. 6 and an orange in FIG. 7.

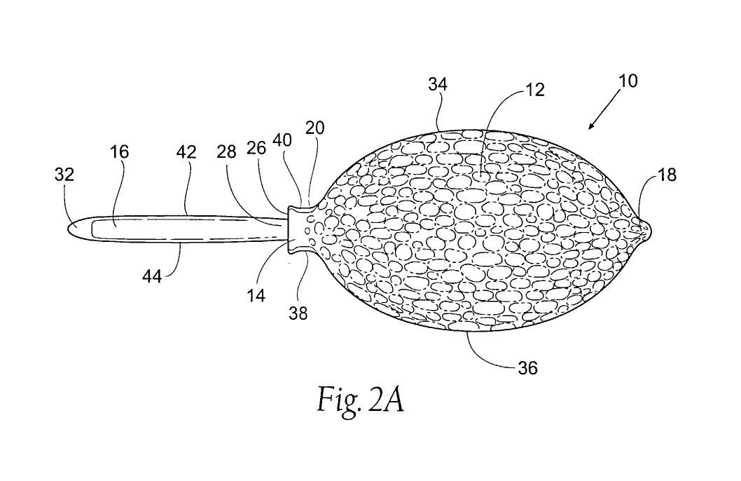

Still referring to FIG. 1, the finger rest 14 may be seen. The finger rest 14 includes a first end 24 connected to the proximal end 20 of the handle 12, and a second end 26 arranged for engagement with blade member 16. As seen, the finger rest 14 preferably longitudinally extends from the proximal end 20 of handle member 12 and extends a predetermined distance from the proximal end 20. The finger rest 14 and the handle member 12 may be fabricated from separate components as in FIGS. 1 and 2, and assembled using conventional means, or, alternatively, may be formed in a one-piece construction (seen in FIG. 2A). The handle 12 and the finger rest 14 are preferably made in a plastic injection molding process. However, any suitable process or material for forming 3-dimensional objects would suffice in forming the handle and finger rest.

As seen in FIGS. 1-2A, the second end 26 of the finger rest 14 is adapted to receive adjoining end 28 of blade member 16. The blade member 16 is preferably arcuately shaped, approximately the contour of a citrus fruit. The blade member 16 is preferably shaped to continuously arc away from its adjoining end 28, reaching a maximum arcuate height at approximately intermediate point 30 (seen in FIG. 1), and thereafter continuously arc away from point 30 to tip 32. The blade member 16 is preferably formed from stainless steel or similar metal suitable for use in the food industry, however it is to be understood that any sufficiently rigid material suitable for use in the food preparation industry may be used for blade 16 construction.

Referring now to FIG. 2, a top plan view of the novel citrus peeler 10 is shown. As mentioned above, the handle member 12 is preferably of an ovoid shape and includes opposed sides 34 and 36. As seen particularly in the view of FIG. 2, opposed sides 34 and 36 are spaced apart at a width somewhat greater than the width of finger rest 14 and the blade member 16. As may be seen, the finger rest 14 extends longitudinally from the proximal end 20 of the handle member 12 in the same plane as the blade member 16. The ovoid, generally fruit-shaped dimensions of the handle 12 and the relationship of the handle 12 to the finger rest 14 allow for facile grasping of the citrus peeler 10.

Still referring to FIG. 2, the finger rest 14 is seen as preferably including a pair of opposed, concave sides, 38 and 40. The concavity of the sides 38 and 40 is preferred to thereby conform to the contour of a user's fingers (not seen in this view) when the citrus peeler 10 is in use. The concave feature of sides 38 and 40 provides comfort to the user, as well as support for both left or right handed users, as the finger rest 14 provides the user with finger support and protection from abrasion by the blade member 16 during use.

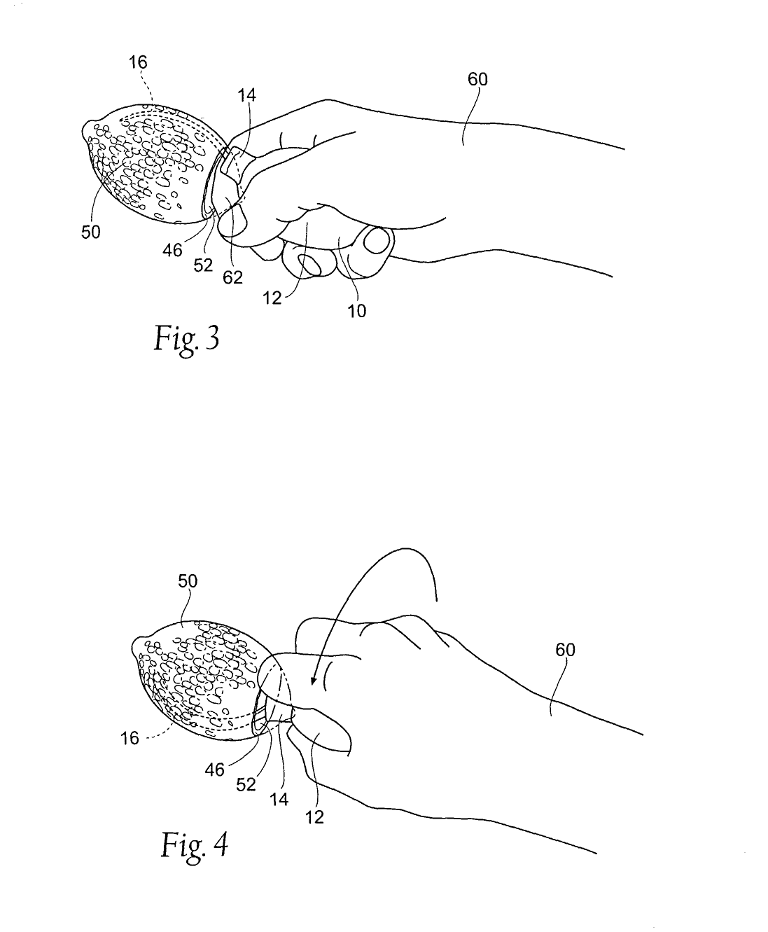

As further shown in FIG. 2, the blade 16 preferably includes at least one longitudinally extending beveled edge 42 and 44. The edges 42 and 44 are honed to a suitable edge sharpness as desired, to facilitate removal of a fruit rind 46 from the meat 48 of a piece of fruit 50 (seen in FIGS. 3, 4, and 5). The edges 42 and 44 converge at a tip 32 portion of the blade 16. The tip 32 is preferably somewhat rounded and may be used to pierce the rind 46 of a piece of fruit 50 to thereby initiate the peeling process. Alternatively, and as seen in FIGS. 3-5, inclusive, an end 52 of the fruit 50 may be removed first, and the tip 32 inserted between the rind 46 and the meat 48 of the fruit 50 and the sliced end 52. The tip 32 of the blade 16, along with the edges 42 and 44, provide the ability to enter a piece of fruit 50 and remove the rind 46 from the meat 48. The unique shape of the blade 16 is designed to allow rind removal without necessitating an overly sharp edge. This feature helps to minimize user injury due to undue blade sharpness. Further, since the blade 16 functions with minimal sharpness, the rind 46 may be removed with little or no damage, thus allowing various uses of an intact rind.

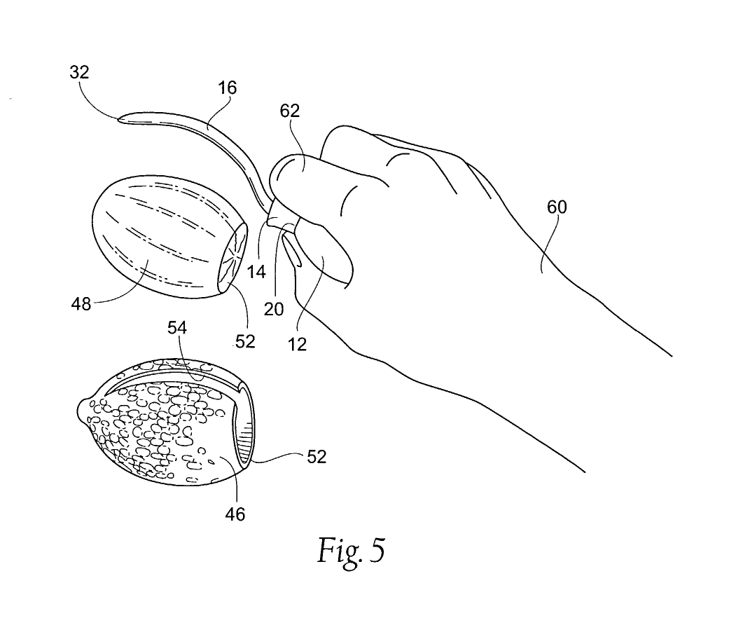

FIGS. 3-5, inclusive, show the citrus peeler 10 in use in conjunction with a fruit 50. As seen in FIGS. 3 and 4, the blade member 16 is shown by means of a broken line, and positioned within the fruit 50. With the blade member 16 in place between the rind 46 and meat 48, the fruit 50 or tool 10 is rotated, and the blade member 16 circumscribes the fruit 50, thereby pulling the peel or rind 46 from the fruit meat 48. After the peel or rind 46 is loosened from the meat 48, the loosely surrounding rind 46 may be removed, as seen in FIG. 5, by lifting the blade member 16 to thereby form a longitudinal cut 54 in rind 46. The peel 46 is then easily removed from the fruit meat 48. The removed peel 46 may be used for zest or garnish or may be stored for later use.

As shown particularly in FIG. 3, an end 52 of the fruit 50 may be removed to ease the entrance of the blade 16. However, as seen in the previous Figures, the tip 32 of the blade 16 is sufficiently tapered to pierce the rind 46 without removal of an end 52, if necessary. A person's hand 60 is shown easily gripping the handle 12. Also, as seen in the views of FIGS. 3-5, a user's finger 62 comfortably rests against the finger rest 14 without having the finger 62 come into contact with the blade member 16.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A device for removing the rind from a fruit comprising:
a handle member, said handle member having a distal and proximal end;
a finger rest, said finger rest longitudinally extending from said proximal end of said handle member, said finger rest including a distal end; and
a blade member, said blade member longitudinally extending from said distal end of said finger rest, and terminating in a tapered tip.

2. The device of claim 1 wherein said handle member has a generally ovoid shape.

3. The device of claim 1 wherein said handle member has a whole fruit shape.

4. The device of claim 1 wherein said handle member includes a flattened bottom surface portion.

5. The device of claim 1 wherein said finger rest includes a pair of oppositely disposed, concave sides.

6. The device of claim 1 wherein said blade member is arcuately shaped.

7. The device of claim 6 wherein said blade member includes at least one longitudinally coextensive beveled edge.

8. The device of claim 6 wherein said blade member includes a pair of oppositely disposed, longitudinally extending beveled edges.

9. The device of claim 1 wherein said handle member and said finger rest are integrally formed as a one-piece construction.

10. The device according to claim 6, wherein said arcuately shaped blade member forms an arc similar to the shape of a citrus fruit.

11. The device of claim 1 wherein said finger rest and said handle member are formed from separate pieces of material.

12. The device of claim 1 wherein said blade member is made of a stainless steel.

13. In combination:
a rinding surface carried by a whole fruit-depicting handle.

14. The combination of claim 13 wherein said handle is a lemon.

15. The combination of claim 13 wherein said handle is a lime.

16. The combination of claim 13 wherein said handle is an orange.

17. The combination of claim 13 wherein said rinding surface is an arcuate blade.

18. A method of derinding a fruit including the steps of:
providing a derinding tool comprising a handle member, said handle member having a distal end and a proximal end; a finger rest, said finger rest longitudinally extending from said proximal end of said handle member, said finger rest including a distal end; an arcuate blade member, said blade member longitudinally extending from said distal end of said finger rest, and terminating in a tapered tip;
providing a fruit member having at least a rind portion, meat portion and an end portion;
inserting said tapered tip of said blade member into said end portion of said fruit member;
sliding said blade member between said meat portion and said rind portion;
providing relative rotational motion between said fruit member and said blade member to thereby loosen said rind portion from said meat portion; and
lifting said blade member through said loosened rind portion to thereby cut said loosened rind portion from said meat portion.

19. A peeler for separating a fruit rind from a fruit meat of a citrus fruit, said peeler including a whole fruit-depicting handle and an elongated rinding blade member including a rinding surface and extending longitudinally from an end of said handle.

20. The peeler of claim 19 wherein said handle is formed in the shape of a lemon.

21. The peeler of claim 19 wherein said handle is formed in the shape of a lime.

22. The peeler of claim 19 wherein said handle is formed in the shape of an orange.

23. The peeler of claim 19 wherein said rinding surface is arcuately formed and approximates the contour of a surface defined by the fruit meat and contiguous fruit rind.

24. The peeler of claim 23 wherein said rinding surface includes at least one honed edge.

25. The peeler of claim 23 wherein said at rinding surface includes a pair of oppositely disposed, longitudinally extending honed edges.

26. The peeler of claim 19 wherein said handle includes a flattened bottom portion.
